(19) United States
(12) Patent Application Publication
(10) Pub. No.: US 2026/0011754 A1
(43) Pub. Date: Jan. 8, 2026

(54) Method for Manufacturing Fuel Cell Separator and Fuel Cell Separator

(71) Applicants: NOK CORPORATION, Tokyo (JP); Honda Motor Co., Ltd., Tokyo (JP)

(72) Inventors: Yohei SANO, Fujisawa (JP); Daiki SHIGENARI, Shizuoka (JP); Toshihiro SHIMAZOE, Kikugawa (JP); Kentaro ISHIDA, Saitama (JP); Hiroyuki ISHIKAWA, Saitama (JP)

(21) Appl. No.: 19/257,872

(22) Filed: Jul. 2, 2025

(30) Foreign Application Priority Data
Jul. 4, 2024 (JP) 2024-108237

(51) Int. Cl. H01M 8/0254; H01M 8/0258

(52) U.S. Cl. CPC H01M 8/0254; H01M 8/0258

(57) ABSTRACT

To suppress a situation in which a separator is deformed due to pre-pressing performed on bead parts, a manufacturing method is provided that includes a press forming step of forming a first separator and a second separator by performing press forming on metal materials. Next, in a joining step, the first separator and the second separator are joined such that bead parts and a plurality of bridge parts face away from bead parts and a plurality of bridge parts. The manufacturing method also includes a pre-pressing step of plastically deforming the bead parts of the first separator and the second separator by applying a preload to the bead parts, the first separator and the second separator being joined together. In this pre-pressing step, deformation is suppressed at the plurality of bridge parts and at portions on bottom parts between the plurality of bridge parts.

### CROSS REFERENCE TO RELATED APPLICATIONS

The present application is based upon and claims the benefit of priority from Japanese Patent Application No. 2024-108237, filed on Jul. 4, 2024, the entire contents of which are incorporated herein by reference.

### BACKGROUND

### Technical Field

The present disclosure relates to a method for manufacturing a fuel cell separator, and to a fuel cell separator.

### Background Art

A fuel cell is formed by stacking a plurality of fuel battery cells. For example, the fuel battery cell of a solid polymer fuel cell is constituted of a membrane electrode assembly (MEA) and separators, the membrane electrode assembly being formed by sandwiching a solid polymer electrolyte membrane between an anode electrode and a cathode electrode to form an integral body, the separators sandwiching the membrane electrode assembly. There are fuel battery cells that use metal separators, and some of such metal separators have bead parts to form flow passages for reaction gases or a cooling medium.

When a load in the stacking direction of the fuel battery cells fluctuates in the fuel cell, there may be cases in which the bead parts formed on the separator receive this load, and are thus plastically deformed. In the case in which the bead parts of the separator are plastically deformed, when the fluctuation in load in the fuel cell is eliminated, there may be cases in which the surface pressure on the bead parts becomes lower than a desired surface pressure and, in addition, there may also be cases in which there are variations in surface pressure and, in this case, flow passages with no leakage are not formed. To solve such problems, conventionally, pre-pressing is performed to plastically deform the bead parts by applying a load in advance to the bead parts (see Japanese Patent Laid-Open No. 2017-139218, for example).

Due to pre-pressing performed on the bead parts, there may be cases in which a separator is deformed at a portion that is not a bead part. Therefore, conventionally, a configuration has been devised to suppress a situation in which the separator is deformed due to pre-pressing (see Japanese Patent Laid-Open No. 2023-150877, for example).

The deformation of the separator may lead to a reduction or variation in surface pressure on the bead parts in the fuel cell. Therefore, there has been a continuous demand for a technique that can suppress a situation in which a separator is deformed due to pre-pressing performed on bead parts.

The present disclosure is related to providing a method for manufacturing a fuel cell separator that can suppress a situation in which a separator is deformed due to pre-pressing performed on bead parts, and to providing the fuel cell separator.

### SUMMARY

In accordance with one aspect of the present disclosure, a method for manufacturing a fuel cell separator includes a step of plastically deforming a bead part of a first separator and a bead part of a second separator by applying a preload to the bead part of the first separator and the bead part of the second separator, the first separator and the second separator being joined such that the bead part of the first separator and the bead part of the second separator face away from each other, the bead part protruding from a bottom part and a plurality of bridge parts protruding from the bottom part being formed on the first separator, the plurality of bridge parts forming flow passages that communicate with the bead part, the bead part protruding from a bottom part and a plurality of bridge parts protruding from the bottom part being formed on the second separator, the plurality of bridge parts forming flow passages that communicate with the bead part, wherein in a step of applying the preload, a deformation suppressing member is used to suppress deformation at the plurality of bridge parts and at a portion of the bottom part between the plurality of bridge parts.

In the method for manufacturing a fuel cell separator according to one aspect of the present disclosure, in the step of applying the preload, the plurality of bridge parts facing away from each other are sandwiched by a pair of the deformation suppressing members to suppress deformation at the plurality of bridge parts and at the portion of the bottom part.

In the method for manufacturing a fuel cell separator according to one aspect of the present disclosure, one of the pair of the deformation suppressing members is a plate-shaped member that is capable of contacting at least a portion of the plurality of bridge parts formed on the first separator, from a side opposite to a side on which the first separator is joined, in such a way as to cover at least the portion of the plurality of bridge parts, and another of the pair of the deformation suppressing members is a plate-shaped member that is capable of contacting at least a portion of the plurality of bridge parts formed on the second separator, from a side opposite to a side on which the second separator is joined, in such a way as to cover at least the portion of the plurality of bridge parts.

In the method for manufacturing a fuel cell separator according to one aspect of the present disclosure, a thickness in a joining direction of each of the pair of the deformation suppressing members is set based on a height in the joining direction of the bead part that is plastically deformed.

In the method for manufacturing a fuel cell separator according to one aspect of the present disclosure, the preload is applied with the deformation suppressing member placed at least on a portion of the plurality of bridge parts.

In the method for manufacturing a fuel cell separator according to one aspect of the present disclosure, the deformation suppressing member is placed on a pressing plate in such a way as to face at least a portion of the plurality of bridge parts, the pressing plate being configured to apply the preload.

In the method for manufacturing a fuel cell separator according to one aspect of the present disclosure, the preload is applied with the deformation suppressing member bonded to at least a portion of the plurality of bridge parts.

In the method for manufacturing a fuel cell separator according to one aspect of the present disclosure, the preload is applied with the deformation suppressing member bonded to the pressing plate.

In the method for manufacturing a fuel cell separator according to one aspect of the present disclosure, a plurality of the bead parts are formed in a press forming step.

In the method for manufacturing a fuel cell separator according to one aspect of the present disclosure, at least one different bead part is formed in the press forming step.

To achieve the above-mentioned object, in accordance with one aspect of the present disclosure, a fuel cell separator includes: a first separator on which a bead part and a plurality of bridge parts are formed; a second separator on which a bead part and a plurality of bridge parts are formed; and a pair of deformation suppressing members each of which is a plate-shaped member, wherein the first separator and the second separator are joined such that the bead part of the first separator and the bead part of the second separator face away from each other, one of the pair of deformation suppressing members covers at least a portion of the plurality of bridge parts formed on the first separator, and another of the pair of deformation suppressing members covers at least a portion of the plurality of bridge parts formed on the second separator.

In the fuel cell separator according to one aspect of the present disclosure, the bead part of the first separator and the bead part of the second separator exhibit no plastic deformation caused by application of a preload, the first separator and the second separator being joined together.

In the fuel cell separator according to one aspect of the present disclosure, the bead part of the first separator and the bead part of the second separator are plastically deformed due to application of a preload, the first separator and the second separator being joined together.

In the fuel cell separator according to one aspect of the present disclosure, a thickness of each of the pair of deformation suppressing members is set based on a height in a joining direction of the bead part that is plastically deformed due to application of a preload.

In the fuel cell separator according to one aspect of the present disclosure, a deformation suppressing member of the pair of deformation suppressing members is bonded to at least a portion of the plurality of bridge parts.

In the fuel cell separator according to one aspect of the present disclosure, the first separator includes a plurality of the bead parts, and the second separator includes a plurality of the bead parts.

In the fuel cell separator according to one aspect of the present disclosure, the first separator includes a plurality of different bead parts, and the second separator includes a plurality of different bead parts.

### Effect(s) of Disclosure

The method for manufacturing a fuel cell separator and the fuel cell separator according to the present disclosure can suppress a situation in which the separator is deformed due to pre-pressing performed on the bead parts.

### BRIEF DESCRIPTION OF THE DRAWINGS

FIG. 1 is a diagram schematically showing a fuel cell separator according to an embodiment of the present disclosure;

FIG. 2 is a diagram schematically showing the fuel cell separator according to the embodiment of the present disclosure;

FIG. 3 is a diagram showing a portion of a first separator in the vicinity of a through hole in an enlarged manner;

FIG. 4 is a cross-sectional view showing a cross section taken along line A-A in FIG. 3;

FIG. 5 is a plan view schematically showing the configuration of a fuel battery cell;

FIG. 6 is a partial cross-sectional view of a fuel cell;

FIG. 7 is a diagram showing a flowchart of a method for manufacturing a fuel cell separator according to the embodiment of the present disclosure;

FIG. 8 is a diagram for illustrating a known method for suppressing deformation;

FIG. 9 is a diagram for illustrating a method for suppressing deformation in the manufacturing method according to the embodiment of the present disclosure;

FIG. 10 is a cross-sectional view showing a cross section taken along line B-B in FIG. 9;

FIG. 11 is a cross-sectional view for illustrating a modification of the method for suppressing deformation according to the embodiment of the present disclosure;

FIG. 12 is a diagram schematically showing a fuel cell separator according to another embodiment of the present disclosure; and

FIG. 13 is a diagram schematically showing the fuel cell separator according to another embodiment of the present disclosure.

### DETAILED DESCRIPTION

Hereinafter, embodiments of the present disclosure will be described with reference to drawings. In the drawings, reference symbols may not be given for all of a plurality of constituent elements, and reference symbols for some of the plurality of constituent elements may be omitted.

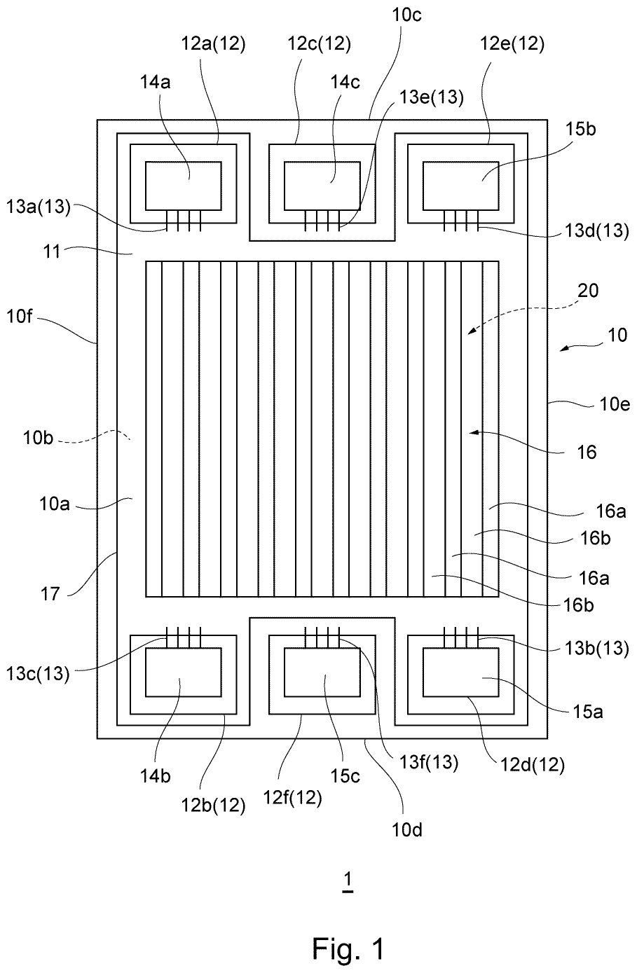

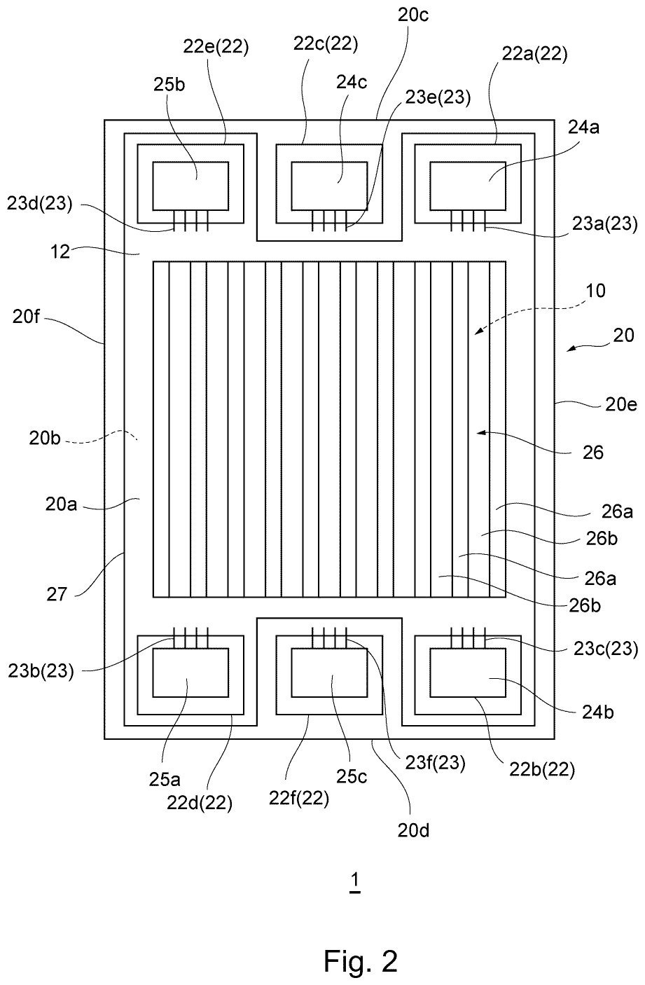

A fuel cell separator according to the present disclosure is a separator that sandwiches a membrane electrode assembly in a fuel battery cell. FIGS. 1 and 2 are diagrams schematically showing a fuel cell separator 1 according to the embodiment of the present disclosure. FIG. 1 shows one side of the fuel cell separator 1, and FIG. 2 shows the opposite side, that is, the other side, of the fuel cell separator 1. As shown in FIGS. 1 and 2, the fuel cell separator 1 includes a first separator 10 and a second separator 20, and the first separator 10 and the second separator 20 are joined together. Bead parts 12 and a plurality of bridge parts 13 are formed on the first separator 10, the bead parts 12 protruding from a bottom part 11, the plurality of bridge parts 13 protruding from the bottom part 11 to form flow passages that communicate with the bead parts 12. Bead parts 22 and a plurality of bridge parts 23 are formed on the second separator 20, the bead parts 22 protruding from a bottom part 21, the plurality of bridge parts 23 protruding from the bottom part 21 to form flow passages that communicate with the bead parts 22. The first separator 10 and the second separator 20 are joined such that the bead parts 12 of the first separator 10 and the bead parts 22 of the second separator 20 face away from each other. With respect to the fuel cell separator 1, in a pre-pressing step of applying a preload described later, deformation at the plurality of bridge parts 13 and at portions of the bottom part 11 between the plurality of bridge parts 13 is suppressed and, in the same manner, deformation at the plurality of bridge parts 23 and at portions of the bottom part 21 between the plurality of bridge parts 23 is suppressed. Hereinafter, the configuration of the fuel cell separator 1 will be specifically described.

In the fuel cell, the fuel cell separator 1 constitutes portions at which adjacent fuel battery cells are coupled to each other. The first separator 10 of the fuel cell separator 1 constitutes one portion of adjacent fuel battery cells, and the second separator 20 of the fuel cell separator 1 constitutes the other portion of the adjacent fuel battery cells. The first separator 10 forms a flow passage for one of either oxidant gas or fuel gas in the fuel battery cell, and the second separator 20 forms a flow passage for the other of either oxidant gas or fuel gas in the fuel battery cell. The fuel cell separator 1 also forms a passage for a cooling medium between the first separator 10 and the second separator 20. The oxidant gas is, for example, oxygen-containing gas, the fuel gas is, for example, hydrogen-containing gas, and the cooling medium is, for example, water. In the present embodiment, it is assumed that, for example, the first separator 10 forms the flow passage for oxidant gas in the fuel battery cell, and the second separator 20 forms the flow passage for fuel gas in the fuel battery cell.

Each of the first separator 10 and the second separator 20 is made of a metal material, and is made of, for example, a thin metal sheet, such as a steel sheet, a stainless steel sheet, a titanium sheet, an aluminum sheet, or a plated steel sheet. Corrosion-resistant surface treatment is performed on the metal surfaces of the first separator 10 and the second separator 20, for example. The thickness of the first separator 10 and the second separator 20 is, for example, a thickness between 0.05 mm and 0.5 mm. Each of the first separator 10 and the second separator 20 has a structure having a function similar to the function of a separator used in the fuel battery cell of a known fuel cell. The structure of each of the first separator 10 and the second separator 20 is at least partially formed by press forming, and each of the first separator 10 and the second separator 20 has concaves and convexes. To be more specific, the first separator 10 includes the bottom part 11 and portions protruding from the bottom part 11 on the front surface side, the bottom part 11 being a portion extending along a flat plane or a substantially flat plane. In the same manner, the second separator 20 includes the bottom part 21 and portions protruding from the bottom part 21 on the front surface side, the bottom part 21 being a portion extending along a flat plane or a substantially flat plane. Note that the front surface side is the side toward the direction in which a front surface 10a, 20a described later faces. The side toward the direction in which a back surface 10b, 20b described later faces is a back surface side. Further, a thickness is a width in a direction in which the first separator 10 and the second separator 20 are joined together (joining direction), and is a width in a direction orthogonal to the bottom part 11.

As shown in FIG. 1, for example, the first separator 10 is a rectangular plate-shaped member, has the front surface 10a and the back surface 10b, forming a pair of opposing surfaces, and also has four end parts 10c, 10d, 10e, 10f. The end part 10c and the end part 10d face each other, and the end part 10e and the end part 10f face each other. As shown in FIG. 1, the first separator 10 has six through holes 14a, 14b, 14c, 15a, 15b, 15c at the bottom part 11. The six through holes 14a, 14b, 14c, 15a, 15b, 15c are through holes for forming an oxidant gas supply passage, a fuel gas supply passage, a cooling medium supply passage, an oxidant gas discharge passage, a fuel gas discharge passage, and a cooling medium discharge passage in the fuel battery cell. As shown in FIG. 1, for example, the through holes 14a, 14c, 15b are arranged along the end part 10c of the first separator 10, and the through holes 14b, 15c, 15a are arranged along the end part 10d of the first separator 10.

As shown in FIG. 1, the first separator 10 has a gas flow passage 16 between the portion where the through holes 14a, 14c, 15b are formed and the portion where the through holes 14b, 15c, 15a are formed, the gas flow passage 16 extending along the end parts 10e, 10f. As shown in FIG. 1, for example, the gas flow passage 16 includes a plurality of protruding parts 16a extending along the end parts 10e, 10f, and protruding on the front surface side, and also includes a plurality of groove parts 16b formed between the plurality of protruding parts 16a. The plurality of protruding parts 16a and the plurality of groove parts 16b form a flow passage for gas, the flow passage extending along the end parts 10e, 10f. In the present embodiment, the gas flow passage 16 forms a flow passage for oxidant gas.

As described above, the first separator 10 includes the plurality of bead parts 12. The first separator 10 also includes a bead part 17, which is a different bead part. The bead parts 12, 17 are portions formed by press forming, and protruding on the front surface side, and form grooves recessed on the back surface 10b toward the front surface side. As will be described later, a rubber layer 33 made of a rubber material is mounted on the top parts of the bead parts 12, 17. The rubber material for forming the rubber layer 33 is printed or coated, for example, on the top parts of the bead parts 12, 17, and is then vulcanized to be firmly fixed to the top parts of the bead parts 12, 17. The rubber layers 33 increase adhesion between the bead parts 12, 17 and counterpart members contacted by the bead parts 12, 17. The rubber layers 33 need not be provided to the top parts of the bead parts 12, 17.

As shown in FIG. 1, the first separator 10 includes, as the bead parts 12, through hole bead parts 12a, 12b, 12c, 12d, 12e, 12f, which are bead parts that respectively surround six through holes 14a, 14b, 14c, 15a, 15b, 15c. As shown in FIG. 1, the first separator 10 also includes a gas flow passage bead part 17 as a different bead part 17. As shown in FIG. 1, the gas flow passage bead part 17 extends along the end parts 10c, 10d, 10e, 10f of the first separator 10. At the end part 10c, the gas flow passage bead part 17 surrounds the through hole bead parts 12a, 12e, but does not surround the through hole bead 12c, the through hole bead parts 12a, 12e respectively surrounding the through holes 14a, 15b, which respectively correspond to the oxidant gas supply passage and the fuel gas discharge passage, the through hole bead 12c surrounding the through hole 14c, which corresponds to the cooling medium supply passage. At the end part 10d, the gas flow passage bead part 17 surrounds the through hole bead parts 12b, 12d, but does not surround the through hole bead 12f, the through hole bead parts 12b, 12d respectively surrounding the through holes 14b, 15a, which respectively correspond to the fuel gas supply passage and the oxidant gas discharge passage, the through hole bead 12f surrounding the through hole 15c, which corresponds to the cooling medium discharge passage.

As shown in FIG. 1, the first separator 10 includes, as the plurality of bridge parts 13, a plurality of bridge parts 13a, a plurality of bridge parts 13b, a plurality of bridge parts 13c, a plurality of bridge parts 13d, a plurality of bridge parts 13e, and a plurality of bridge parts 13f. The bridge parts 13 are portions protruding on the front surface side, and form grooves recessed on the back surface 10b toward the front surface side. The space of each bridge part 13, which is recessed on the back surface 10b toward the front surface side, communicates with the space of the bead part 12, which is recessed on the back surface 10b toward the front surface side.

The plurality of bridge parts 13a are portions for allowing the through hole 14a, which corresponds to the oxidant gas supply passage, to communicate with the gas flow passage 16, and penetrate through the through hole bead part 12a to communicate with the gas flow passage 16 on the front surface side. The plurality of bridge parts 13b are portions for allowing the through hole 15a, which corresponds to the oxidant gas discharge passage, to communicate with the gas flow passage 16, and penetrate through the through hole bead part 12d to communicate with the gas flow passage 16 on the front surface side.

The plurality of bridge parts 13c are portions for allowing the through hole 14b, which corresponds to the fuel gas supply passage, to communicate with a gas flow passage 26 of the second separator 20 described later, and penetrate through the through hole bead part 12b to communicate with the gas flow passage 26 in the second separator 20. The plurality of bridge parts 13d are portions for allowing the through hole 15b, which corresponds to the fuel gas discharge passage, to communicate with the gas flow passage 26, and penetrate through the through hole bead part 12e to communicate with the gas flow passage 26 in the second separator 20.

The plurality of bridge parts 13e are portions for allowing the through hole 14c, which corresponds to the cooling medium supply passage, to communicate with a cooling medium flow passage, and penetrate through the through hole bead part 12c to allow the through hole 14c to communicate with the cooling medium flow passage. The plurality of bridge parts 13e communicate with the cooling medium flow passage on the back surface side. The plurality of bridge parts 13f are portions for allowing the through hole 15c, which corresponds to the cooling medium discharge passage, to communicate with the cooling medium flow passage, and penetrate through the through hole bead part 12f to allow the through hole 15c to communicate with the cooling medium flow passage. The plurality of bridge parts 13f communicate with the cooling medium flow passage on the back surface side.

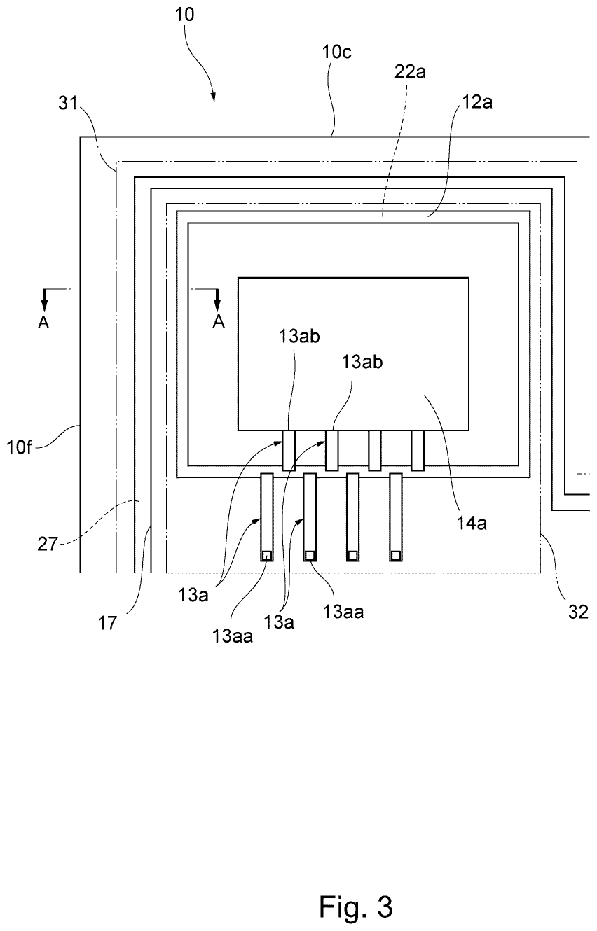

FIG. 3 is a diagram showing a portion of the first separator 10 in the vicinity of the through hole 14a in an enlarged manner. As described above, the through hole 14a is the through hole that corresponds to the oxidant gas supply passage. As shown in FIG. 3, for example, each bridge part 13a extends along the gas flow passage 16, and includes a portion extending from the through hole bead part 12a toward the gas flow passage 16, and a portion extending from the through hole bead part 12a toward the through hole 14a. The bridge part 13a has an open hole 13aa at a position closer to the gas flow passage 16 than the through hole bead part 12a, the open hole 13aa being a hole that is open on the front surface side. An end part 13ab of each bridge part 13a on the through hole 14a side is open to the through hole 14a.

As shown in FIG. 3, the portion of the bridge part 13a on the gas flow passage 16 side and the portion of the bridge part 13a on the through hole 14a side need not be arranged in a straight line, but may be arranged in a straight line. Other bridge parts 13 have a similar configuration, and are open in the same manner for communication.

As shown in FIG. 1, for example, the second separator 20 is a rectangular plate-shaped member, has the front surface 20a and the back surface 20b, forming a pair of opposing surfaces, and also has four end parts 20c, 20d, 20e, 20f. The end part 20c and the end part 20d face each other, and the end part 20e and the end part 20f face each other. The second separator 20 has the same or substantially the same size as the first separator 10. As shown in FIG. 2, the second separator 20 has six through holes 24a, 24b, 24c, 25a, 25b, 25c at the bottom part 21. The six through holes 24a, 24b, 24c, 25a, 25b, 25c are through holes for forming an oxidant gas supply passage, a fuel gas supply passage, a cooling medium supply passage, an oxidant gas discharge passage, a fuel gas discharge passage, and a cooling medium discharge passage in the fuel battery cell. As shown in FIG. 2, for example, the through holes 25b, 24c, 24a are arranged along the end part 20c of the second separator 20, and the through holes 25a, 25c, 24b are arranged along the end part 20d of the second separator 20.

As shown in FIG. 2, the second separator 20 has the gas flow passage 26 between the portion where the through holes 25b, 24c, 24a are formed and the portion where the through holes 25a, 25c, 24b are formed, the gas flow passage 26 extending along the end parts 20e, 20f. As shown in FIG. 2, for example, the gas flow passage 26 includes a plurality of protruding parts 26a extending along the end parts 20e, 20f, and protruding on the front surface side, and also includes a plurality of groove parts 26b formed between the plurality of protruding parts 26a. The plurality of protruding parts 26a and the plurality of groove parts 26b form a flow passage for gas, the flow passage extending along the end parts 20e, 20f. In the present embodiment, the gas flow passage 26 forms the flow passage for fuel gas.

As described above, the second separator 20 includes the plurality of bead parts 22. The second separator 20 also includes a bead part 27, which is a different bead part. The bead parts 22, 27 are portions formed by press forming, and protruding on the front surface side, and form grooves recessed on the back surface 20b toward the front surface side. The rubber layer 33 is mounted on the top parts of the bead parts 22, 27. The rubber layer 33 need not be provided to the top parts of the bead parts 22, 17.

As shown in FIG. 2, the second separator 20 includes, as the bead parts 22, through hole bead parts 22a, 22b, 22c, 22d, 22e, 22f, which are bead parts that respectively surround six through holes 24a, 24b, 24c, 25a, 25b, 25c. As shown in FIG. 2, the second separator 20 also includes the gas flow passage bead part 27 as a different bead part 27. As shown in FIG. 2, the gas flow passage bead part 27 extends along the end parts 20c, 20d, 20e, 20f of the second separator 20. At the end part 20c, the gas flow passage bead part 27 surrounds the through hole bead parts 22a, 22e, but does not surround the through hole bead 22c, the through hole bead parts 22a, 22e respectively surrounding the through holes 24a, 25b, which respectively correspond to the oxidant gas supply passage and the fuel gas discharge passage, the through hole bead 22c surrounding the through hole 24c, which corresponds to the cooling medium supply passage. At the end part 20d, the gas flow passage bead part 27 surrounds the through hole bead parts 22b, 22d, but does not surround the through hole bead 22f, the through hole bead parts 22b, 22d respectively surrounding the through holes 25b, 24b, which respectively correspond to the oxidant gas discharge passage and the fuel gas supply passage, the through hole bead 22f surrounding the through hole 25c, which corresponds to the cooling medium discharge passage.

As shown in FIG. 2, the second separator 20 includes, as the plurality of bridge parts 23, a plurality of bridge parts 23a, a plurality of bridge parts 23b, a plurality of bridge parts 23c, a plurality of bridge parts 23d, a plurality of bridge parts 23e, and a plurality of bridge parts 23f. The bridge parts 23 are portions protruding on the front surface side, and form grooves recessed on the back surface 20b toward the front surface side. The space of each bridge part 23, which is recessed on the back surface 20b toward the front surface side, communicates with the space of the bead part 22, which is recessed on the back surface 20b toward the front surface side.

The plurality of bridge parts 23a are portions for allowing the through hole 24a, which corresponds to the oxidant gas supply passage, to communicate with the gas flow passage 16 of the first separator 10, and penetrate through the through hole bead part 22a to communicate with the gas flow passage 16 in the first separator 10. The plurality of bridge parts 23b are portions for allowing the through hole 25a, which corresponds to the oxidant gas discharge passage, to communicate with the gas flow passage 16, and penetrate through the through hole bead part 22d to communicate with the gas flow passage 16 in the first separator 10.

The plurality of bridge parts 23c are portions for allowing the through hole 24b, which corresponds to the fuel gas supply passage, to communicate with the gas flow passage 26, and penetrate through the through hole bead part 22b to communicate with the gas flow passage 26 on the front surface side. The plurality of bridge parts 23b are portions for allowing the through hole 25b, which corresponds to the fuel gas discharge passage, to communicate with the gas flow passage 26, and penetrate through the through hole bead part 22e to communicate with the gas flow passage 26 on the front surface side.

The plurality of bridge parts 23e are portions for allowing the through hole 24c, which corresponds to the cooling medium supply passage, to communicate with the cooling medium flow passage, and penetrate through the through hole bead part 22c to allow the through hole 24c to communicate with the cooling medium flow passage. The plurality of bridge parts 23c communicate with the cooling medium flow passage on the back surface side. The plurality of bridge parts 23f are portions for allowing the through hole 25c, which corresponds to the cooling medium discharge passage, to communicate with the cooling medium flow passage, and penetrate through the through hole bead part 22f to allow the through hole 25c to communicate with the cooling medium flow passage. The plurality of bridge parts 23f communicate with the cooling medium flow passage on the back surface side.

The bridge parts 23 of the second separator 20 also have a configuration similar to the configuration of the bridge parts 13 of the first separator 10, and are open for communication in the same manner (see FIG. 3).

The first separator 10 and the second separator 20 having the above-described configurations are joined together to form the fuel cell separator 1. In the fuel cell separator 1, the back surface 10b of the first separator 10 faces the back surface 20b of the second separator 20, and the portions of the back surface 10b of the bottom part 11 are joined to the portions of the back surface 20b of the bottom part 21. The first separator 10 and the second separator 20 are joined together by welding or brazing, for example. The first separator 10 and the second separator 20 are specifically joined by laser welding, for example. Portions along the bead parts 12 are joined to portions along the bead parts 22 on the outer peripheral side of the bead part 12 and the bead part 22, for example. To be more specific, as shown in FIG. 3, for example, laser welding is performed along the gas flow passage bead part 17 and the gas flow passage bead part 27 on the outer peripheral side of the gas flow passage bead part 17 and the gas flow passage bead part 27 to form a laser welding line 31, on which the portion of the first separator 10 along the gas flow passage bead part 17 being joined to the portion of the second separator 20 along the gas flow passage bead part 27. In the same manner, laser welding is performed along the through hole bead part 12a and the through hole bead part 22a on the outer peripheral side of the through hole bead part 12a, surrounding the through hole 14a, and of the through hole bead part 22a to form a laser welding line 32, on which the portion of the first separator 10 along the through hole bead part 12a being joined to the portion of the second separator 20 along the through hole bead part 22a. In the same manner, laser welding is performed along the through hole bead parts 12b to 12f and the through hole bead parts 22b to 22f on the outer peripheral side of the through hole bead parts 12b to 12f and the through hole bead parts 22b to 22f to form a laser welding line, on which the portions of the first separator 10 along the through hole bead parts 12b to 12f are joined to the portions of the second separator 20 along the through hole bead parts 22b to 22f.

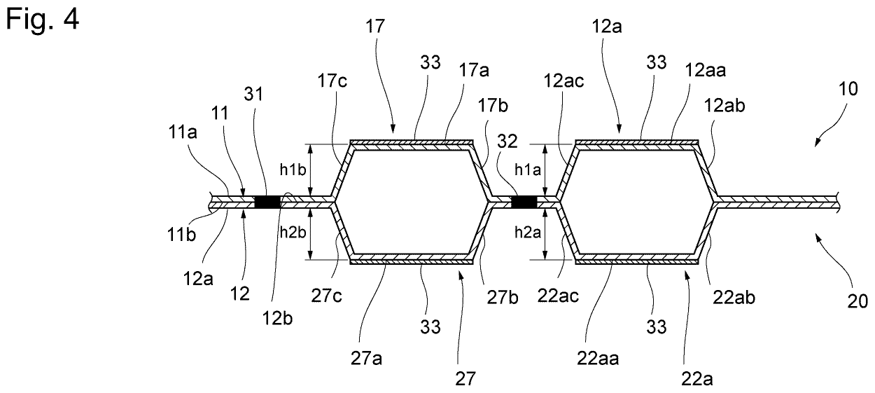

FIG. 4 is a cross-sectional view showing a cross section taken along line A-A in FIG. 3, and shows the cross sections of the gas flow passage bead parts 17, 27 and the through hole beads 12a, 22a disposed adjacent to each other. As shown in FIG. 4, the gas flow passage bead part 17 includes a top part 17a and side wall parts 17b, 17c. The side wall part 17b is an annular portion that protrudes from the bottom part 11 on the front surface side, and the side wall part 17c is an annular portion that faces the side wall part 17b on the outer peripheral side, and that protrudes from the bottom part 11 on the front surface side. The top part 17a is an annular portion that extends between the end part of the side wall part 17b on the front surface side and the end part of the side wall part 17c on the front surface side. As will be described later, the top part 17a is plastically deformed due to the application of a preload. The top part 17a extends along, for example, a flat plane or a substantially flat plane. As shown in FIG. 4, for example, the gas flow passage bead part 17 has a trapezoidal shape or a substantially trapezoidal shape.

As shown in FIG. 4, the through hole bead 12a includes a top part 12aa and side wall parts 12ab, 182c. The side wall part 12ab is an annular portion that protrudes from the bottom part 11 on the front surface side, and the side wall part 12ac is an annular portion that faces the side wall part 12ab on the outer peripheral side, and that protrudes from the bottom part 11 on the front surface side. The top part 12aa is an annular portion that extends between the end part of the side wall part 12ab on the front surface side and the end part of the side wall part 12ac on the front surface side. As will be described later, the top part 12aa is plastically deformed due to the application of a preload. The top part 12aa extends along, for example, a flat plane or a substantially flat plane. The cross sectional shape of the through hole bead 12a is the same or substantially the same as the cross sectional shape of the gas flow passage bead part 17, and a protrusion height h1a of the top part 12aa of the through hole bead 12a is equal or substantially equal to a protrusion height h1b of the top part 17a of the gas flow passage bead part 17. The protrusion height h1a is a distance in the joining direction between the top part 12aa and the bottom part 11, and the protrusion height h1b is a distance in the joining direction between the top part 17a and the bottom part 11. As shown in FIG. 4, for example, the gas flow passage bead 12a has a trapezoidal shape or a substantially trapezoidal shape. Although the cross sectional shape of the gas flow passage bead part 17 may differ from the cross sectional shape of the through hole bead 12a, from the viewpoint of generating a uniform sealing surface pressure, it is preferable that the cross sectional shape of the gas flow passage bead part 17 be the same or substantially the same as the cross sectional shape of the through hole bead 12a. In the same manner, from the viewpoint of generating a uniform sealing surface pressure, it is preferable that the protrusion height h1b of the gas flow passage bead part 17 be equal or substantially equal to the protrusion height h1a of the through hole bead 12a.

In the same manner as the through hole bead 12a, each of the through hole bead parts 12b to 12f of the first separator 10 includes a top part and a pair of side wall parts, and the top part of each of the through hole bead parts 12b to 12f is plastically deformed due to the application of a preload. The through hole bead parts 12b to 12f have the same or substantially the same cross-sectional shape as the through hole bead 12a, and the protrusion height of the top part of each of the through hole bead parts 12b to 12f is equal or substantially equal to the protrusion height h1a of a top part 18aa of the through hole bead 12a. Although the cross sectional shape of the through hole bead parts 12b to 12f may differ from the cross sectional shape of the through hole bead 12a, from the viewpoint of generating a uniform sealing surface pressure, it is preferable that the cross sectional shape of the through hole bead parts 12b to 12f be the same or substantially the same as the cross sectional shape of the through hole bead 12a. In the same manner, from the viewpoint of generating a uniform sealing surface pressure, it is preferable that the protrusion height of the top parts of the through hole bead parts 12b to 12f be equal or substantially equal to the protrusion height h1a of the top part 12aa of the through hole bead 12a.

The gas flow passage bead part 27 of the second separator 20 has substantially the same shape as the gas flow passage bead part 17 of the first separator 10, and the through hole bead parts 22a to 22f of the second separator 20 have substantially the same shape as the through hole bead parts 12a to 12f of the first separator 10. As shown in FIG. 4, the gas flow passage bead part 27 includes a top part 27a and side wall parts 27b, 27c. The side wall part 27b is an annular portion that protrudes from the bottom part 22 on the front surface side, and the side wall part 27c is an annular portion that faces the side wall part 27b on the outer peripheral side, and that protrudes from the bottom part 22 on the front surface side. The top part 27a is an annular portion that extends between the end part of the side wall part 27b on the front surface side and the end part of the side wall part 27c on the front surface side. As will be described later, the top part 27a is plastically deformed due to the application of a preload. The top part 27a extends along, for example, a flat plane or a substantially flat plane. As shown in FIG. 4, for example, the gas flow passage bead part 27 has a trapezoidal shape or a substantially trapezoidal shape.

As shown in FIG. 4, the through hole bead 22a includes a top part 22aa and side wall parts 22ab, 22ac. The side wall part 22ab is an annular portion that protrudes from the bottom part 22 on the front surface side, and the side wall part 22ac is an annular portion that faces the side wall part 22ab on the outer peripheral side, and that protrudes from the bottom part 22 on the front surface side. The top part 22aa is an annular portion that extends between the end part of the side wall part 22ab on the front surface side and the end part of the side wall part 22ac on the front surface side. As will be described later, the top part 22aa is plastically deformed due to the application of a preload. The top part 22aa extends along, for example, a flat plane or a substantially flat plane. The cross sectional shape of the through hole bead 22a is the same or substantially the same as the cross sectional shape of the gas flow passage bead part 27, and a protrusion height h2a of the top part 22aa of the through hole bead 22a is equal or substantially equal to a protrusion height h2b of the top part 27a of the gas flow passage bead part 27. The protrusion height h2a is a distance in the joining direction between the top part 22aa and the bottom part 21, and the protrusion height h2b is a distance in the joining direction between the top part 27a and the bottom part 21. As shown in FIG. 4, for example, the gas flow passage bead 22a has a trapezoidal shape or a substantially trapezoidal shape. Although the cross sectional shape of the gas flow passage bead part 27 may differ from the cross sectional shape of the through hole bead 22a, from the viewpoint of generating a uniform sealing surface pressure, it is preferable that the cross sectional shape of the gas flow passage bead part 27 be the same or substantially the same as the through hole bead 22a. In the same manner, from the viewpoint of generating a uniform sealing surface pressure, it is preferable that the protrusion height h2b of the top part 27a of the gas flow passage bead part 27 be equal or substantially equal to the protrusion height h2a of the top part 22aa of the through hole bead 22a.

In the same manner as the through hole bead 22a, each of the through hole bead parts 22b to 22f of the second separator 20 includes a top part and a pair of side wall parts, and the top part of each of the through hole bead parts 22b to 22f is plastically deformed due to the application of a preload. The through hole bead parts 22b to 22f have the same or substantially the same cross-sectional shape as the through hole bead 22a, and the height of the top part of each of the through hole bead parts 22b to 22f is equal or substantially equal to the protrusion height h2a of the top part 22aa of the through hole bead 22a. Although the cross sectional shape of the through hole bead parts 22b to 22f may differ from the cross sectional shape of the through hole bead 22a, from the viewpoint of generating a uniform sealing surface pressure, it is preferable that the cross sectional shape of the through hole bead parts 22b to 22f be the same or substantially the same as the through hole bead 22a. In the same manner, from the viewpoint of generating a uniform sealing surface pressure, it is preferable that the protrusion height of the top parts of the through hole bead parts 22b to 22f be equal or substantially equal to the protrusion height h2a of the top part 22aa of the through hole bead 22a.

As shown in FIG. 4, in the fuel cell separator 1, the gas flow passage bead part 17 of the first separator 10 and the gas flow passage bead part 27 of the second separator 20 face away from each other. That is, in the direction orthogonal to the joining direction of the fuel cell separator 1, the groove formed by the gas flow passage bead part 17 overlaps with the groove formed by the gas flow passage bead part 27.

As shown in FIG. 4, in the fuel cell separator 1, the through hole bead part 12a of the first separator 10 and the through hole bead part 22a of the second separator 20 face away from each other. That is, in the direction orthogonal to the thickness direction of the fuel cell separator 1, the groove formed by the through hole bead part 12a overlaps with the groove formed by the through hole bead part 22a. In the same manner, in the fuel cell separator 1, the through hole bead parts 12b to 12f of the first separator 10 and the through hole bead parts 22b to 22f of the second separator 20 face away from each other. That is, in the direction orthogonal to the joining direction of the fuel cell separator 1, the grooves formed by the through hole bead parts 12b to 12f overlap with the grooves formed by the through hole bead parts 22b to 22f.

As shown in FIG. 4, the rubber layers 33, which are the above-described rubber members, are formed on the top part 17a of the gas flow passage bead part 17, the top part 27a of the gas flow passage bead part 27, the top part 12aa of the through hole bead part 12a, and the top part 22aa of the through hole bead part 22a. The rubber layers 33 are also formed on the top parts of the through hole bead parts 12b to 12f, 22b to 22f. The rubber layer 33 is a film-like member made of a rubber material.

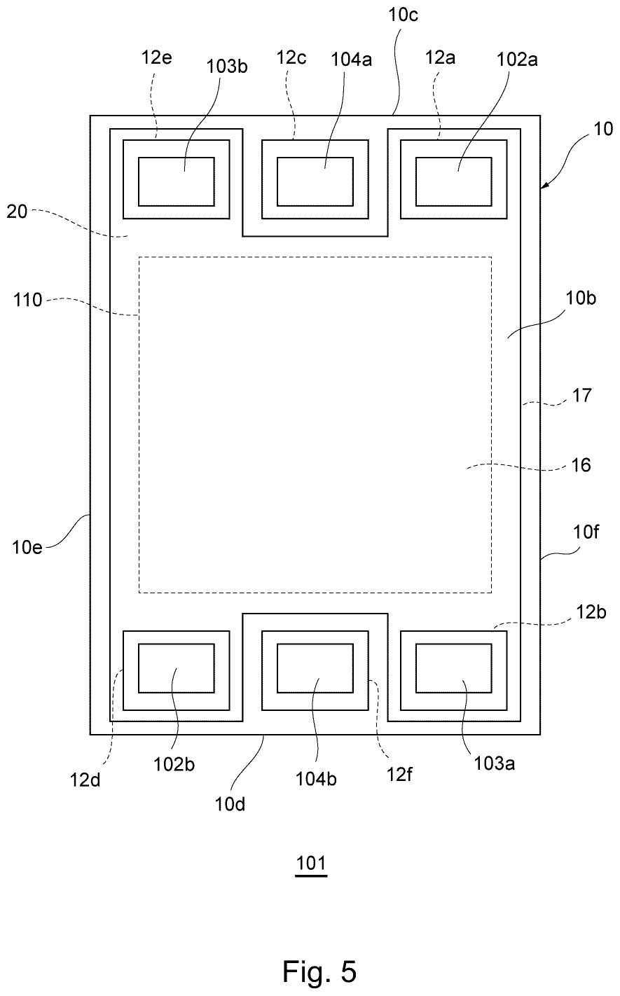

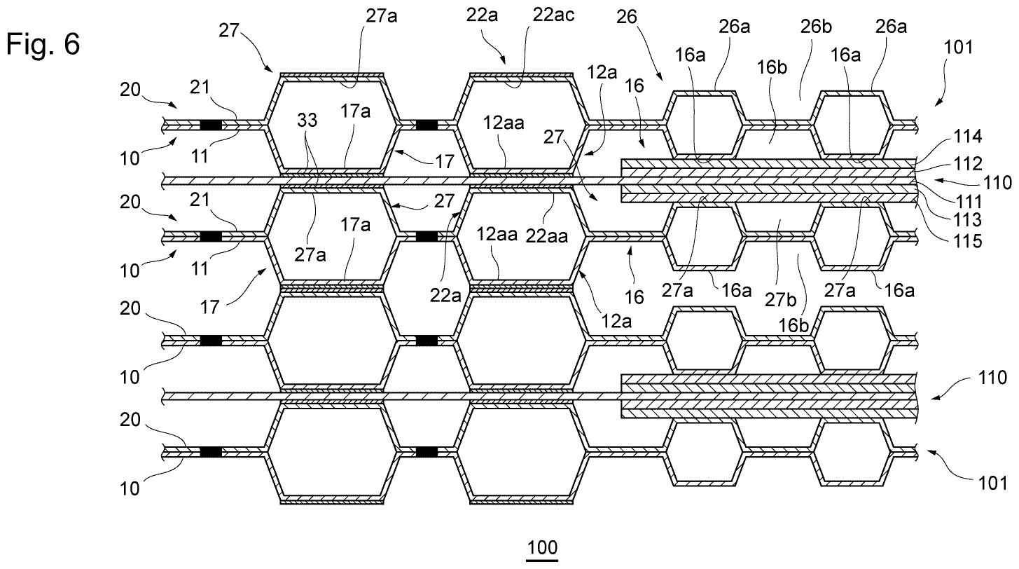

Next, the configuration of a fuel cell 100 that includes the fuel cell separators 1 will be described. FIG. 5 is a plan view schematically showing the configuration of a fuel battery cell 101, and FIG. 6 is a partial cross-sectional view of the fuel cell 100. As shown in FIGS. 5, 6, the fuel battery cell 101 is formed such that a membrane electrode assembly 110 is interposed between the first separator 10 and the second separator 20. The membrane electrode assembly 110 includes an electrolyte membrane 111, a positive electrode catalyst layer 112, which is an anode electrode, a negative electrode catalyst layer 113, which is a cathode electrode, and gas diffusion layers 114, 115. The electrolyte membrane 111 has an outer shape similar to the outer shapes of the first separator 10 and the second separator 20, and overlaps with the front surface 10a of the first separator 10 and the front surface 20a of the second separator 20. The positive electrode catalyst layer 112 is provided on one front surface 111a of the electrolyte membrane 111, and the negative electrode catalyst layer 113 is provided on the other front surface 111b of the electrolyte membrane 111. The positive electrode catalyst layer 112 and the negative electrode catalyst layer 113 face each other with the electrolyte membrane 111 interposed therebetween. The gas diffusion layers 114, 115 are respectively formed on the positive electrode catalyst layer 112 and the negative electrode catalyst layer 113.

In the fuel battery cell 101, the bead parts 12, 17 of each first separator 10 are pushed against the front surface 111a of the electrolyte membrane 111, and a sealed space is formed between the front surface 10a of the first separator 10 and the front surface 111a of the electrolyte membrane 111. To be more specific, the positive electrode catalyst layer 112 and the gas diffusion 114 face the gas flow passage 16 of the first separator 10, and the gas flow passage 16 is sealed by the gas flow passage bead part 17 of the first separator 10. The electrolyte membrane 111 has through holes that face the through holes 14a to 14c, 15a to 15c of the first separator 10, and the through hole bead parts 12a to 12f form sealed spaces that communicate with the through holes 14a to 14c, 15a to 15c and with the through holes that face the through holes 14a to 14c, 15a to 15c, and that are formed in the electrolyte membrane 111.

In the fuel battery cell 101, the bead parts 22, 27 of each second separator 20 are pushed against the front surface 111b of the electrolyte membrane 111, and a sealed space is formed between the front surface 20a of the second separator 20 and the front surface 111b of the electrolyte membrane 111. To be more specific, the negative electrode catalyst layer 113 and the gas diffusion 115 face the gas flow passage 26 of the second separator 20, and the gas flow passage 26 is sealed by the gas flow passage bead part 27 of the second separator 12. Through holes formed in the electrolyte membrane 111 face the through holes 24a to 24c, 25a to 25c of the second separator 20, and the through hole bead parts 22a to 22f form sealed spaces that communicate with the through holes 24a to 24c, 25a to 25c and with the through holes that face the through holes 24a to 24c, 25a to 25c, and that are formed in the electrolyte membrane 111.

As described above, in the fuel battery cell 101, as shown in FIG. 5, the through hole 14a and the through hole 24a are made to communicate with each other through the through hole of the electrolyte membrane 111 to form an oxidant gas supply passage 102a, and the through hole 15a and the through hole 15a are made to communicate with each other through the through hole of the electrolyte membrane 111 to form an oxidant gas discharge passage 102b. In the fuel battery cell 101, the through hole 14b and the through hole 24b are made to communicate with each other through the through hole of the electrolyte membrane 111 to form a fuel gas supply passage 103a, and the through hole 15b and the through hole 25b are made to communicate with each other through the through hole of the electrolyte membrane 111 to form a fuel gas discharge passage 103b. In the fuel battery cell 101, the through hole 14c and the through hole 24c are made to communicate with each other through the through hole of the electrolyte membrane 111 to form a cooling medium supply passage 104a, and the through hole 15c and the through hole 25c are made to communicate with each other through the through hole of the electrolyte membrane 111 to form a cooling medium discharge passage 104b.

In the fuel cell 100, a plurality of fuel battery cells 101 are stacked and fixed. The plurality of stacked fuel battery cells 101 are fastened in the stacking direction, and adjacent fuel battery cells 101 are pushed in the stacking direction. Therefore, in the fuel cell 100, the bead parts 12, 17, 22, 27 are pushed against the electrolyte membranes 111. In the fuel cell 100, the oxidant gas supply passages 102a, the oxidant gas discharge passages 102b, the fuel gas supply passages 103a, the fuel gas discharge passages 103b, the cooling medium supply passages 104, and the cooling medium discharge passages 104b of the stacked fuel battery cells 101 are connected respectively to form flow passages.

As described above, the oxidant gas supply passage 102a and the oxidant gas discharge passage 102b are made to communicate, through the bridge parts 13a, 13b, 23a, 23b, with the space sealed by the gas flow passage bead part 17, and oxidant gas is sealed in the fuel cell 100. The fuel gas supply passage 103a and the fuel gas discharge passage 103b are made to communicate, through the bridge parts 13c, 13d, 23c, 23d, with the space sealed by the gas flow passage bead part 27, and fuel gas is sealed in the fuel cell 100. The cooling medium supply passage 104a and the cooling medium discharge passage 104b are made to communicate, through the bridge parts 13e, 13f, 23e, 23f, with the sealed space formed between the back surface 10b of the first separator 10 and the back surface 20b of the second separator 20, and a cooling medium is sealed in the fuel cell 100.

As described above, in the fuel cell 100, the fuel cell separator 1 constitutes portions at which adjacent fuel battery cells 101 are coupled to each other. Therefore, the fuel battery cell 101 is stacked by stacking, on one of the front surface 10a and the back surface 10b of a fuel cell separator 1, the other of the front surface 10a and the back surface 10b of another fuel cell separator 1 with the membrane electrode assembly 110 interposed therebetween.

As described above, in each fuel battery cell 101 of the fuel cell 100, each of the plurality of bead parts 12, 17 and the plurality of bead parts 22, 27 of the fuel cell separator 1 seals the space surrounded by each bead part. The fuel cell separator 1 is manufactured by a method for manufacturing a fuel cell separator according to the present disclosure described later, and a preload described later is applied to the bead parts 12, 17, 22, 27. Due to the application of this preload, occurrence of deformation is suppressed at the bead parts 12, 17, 22, 27 and portions in the vicinity of the bead parts 12, 17, 22, 27. Particularly, due to the application of a preload in the method for manufacturing a fuel cell separator according to the present disclosure, the occurrence of deformation is suppressed in the bead parts 12, 22 at portions to which the bridge parts 13, 23 are connected, and at portions in the vicinity of such portions.

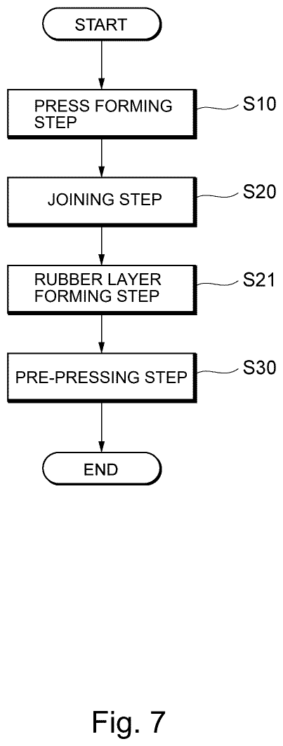

Next, the method for manufacturing a fuel cell separator according to the embodiment of the present disclosure will be described. The above-described fuel cell separator 1 is manufactured by the present manufacturing method. FIG. 7 is a diagram showing a flowchart of the method for manufacturing a fuel cell separator according to the embodiment of the present disclosure.

The present manufacturing method includes a press forming step of forming a first separator 10 and a second separator 20 by press forming metal materials (step S10). Bead parts 12 and a plurality of bridge parts 13 are formed on the first separator 10 by this press forming, the bead parts 12 protruding from a bottom part 11, the plurality of bridge parts 13 protruding from the bottom part 11 to form flow passages that communicate with the bead parts 12. In the same manner, bead parts 22 and a plurality of bridge parts 23 are formed on the second separator 20 by this press forming, the bead parts 22 protruding from a bottom part 21, the plurality of bridge parts 23 protruding from the bottom part 21 to form flow passages that communicate with the bead parts 22. Next, in a joining step (step S20), the first separator 10 and the second separator 20 are joined such that the bead parts 12 and the plurality of bridge parts 13 face away from the bead parts 22 and the plurality of bridge parts 23. The present manufacturing method includes a pre-pressing step (step S30) of plastically deforming the bead parts 12, 22 of the first separator 10 and the second separator 20, which are joined together, by applying a preload to the bead parts 12, 22. In this pre-pressing step, deformation is suppressed at the plurality of bridge parts 13, 23 and at portions on the bottom parts 11, 21 between the plurality of bridge parts 13, 23. Hereinafter, the method for manufacturing a fuel cell separator according to the embodiment of the present disclosure will be specifically described. The present manufacturing method need not include the press forming step and the joining step. In this case, in the present manufacturing method, a first separator 10 and a second separator 20 that are joined together by the press forming step and the joining step are prepared.

To be more specific, in the press forming step (step S10), a gas flow passage bead part 17 is also formed on the first separator 10, and a gas flow passage bead part 27 is also formed on the second separator 20. The concave and convex structures of the first and second separators 10, 20 are formed in the press forming step in this manner. Protrusion heights h1a, h1b, h2a, h2b of the bead parts 12, 17, 22, 27 formed by the press forming step are higher than finished heights, that is, the protrusion heights h1a, h1b, h2a, h2b of the bead parts 12, 17, 22, 27 on which the pre-pressing step is performed.

In the joining step (step S20), the first separator 10 and the second separator 20 are joined together by welding or the like. In the joining step, the back surface 10b of the first separator 10 is brought into contact with the back surface 20b of the second separator 20 and, in this state, the first separator 10 and the second separator 20 are joined together. In the first separator 10 and the second separator 20 joined together, the bead parts 12 and the bead parts 22 face away from each other. To be more specific, the through hole bead parts 12a, 12b, 12c, 12d, 12e, 12f respectively face away from the through hole bead parts 22a, 22b, 22c, 22d, 22e, 22f. In addition, the gas flow passage bead part 17 faces away from the gas flow passage bead part 27. By performing welding in the joining step, as shown in FIG. 3, a laser welding line 31 is formed along the bead parts 17, 27, and a laser welding line 32 is formed along the bead parts 12, 22.

As shown in FIG. 7, the present manufacturing method includes, for example, a rubber layer forming step (step S21). In the rubber layer forming step (step S21), a rubber material is applied to top parts (a top part 12aa and the like) of the bead parts 12, 22, which are formed by the press forming step, to form a rubber layers 33, and a rubber material is applied to top parts 17, 27 of the bead parts 17, 27, which are formed by the press forming step, to form a rubber layer 33. The rubber layers 33 are formed by vulcanizing and bonding the applied rubber material (see FIG. 4).

In the pre-pressing step (step S30), a load of a predetermined magnitude is simultaneously applied to the bead parts 12, 22 and the bead parts 17, 27 of the first separator 10 and the second separator 20 that are joined together. To be more specific, a predetermined load is simultaneously applied to the through hole bead parts 12a, 12b, 12c, 12d, 12e, 12f and the through hole bead parts 22a, 22b, 22c, 22d, 22e, 22f, as well as to the gas flow passage bead part 17 and the gas flow passage bead part 27. The pre-pressing step is a step for plastically deforming the gas flow passage bead part 17 and the through hole bead parts 12a to 12f, thus correcting the heights of the gas flow passage bead part 17 and the through hole bead parts 12a to 12f to a uniform or substantially uniform height and, in the same manner, is a step for plastically deforming the gas flow passage bead part 27 and the through hole bead parts 22a to 22f, thus correcting the heights of the gas flow passage bead part 27 and the through hole bead parts 22a to 22f to a uniform or substantially uniform height. By performing this pre-pressing step, the protrusion height h2a of the gas flow passage bead part 17 and the protrusion height h1a of each of the through hole bead parts 12a to 12f reach a predetermined finished height, and the protrusion height h2b of the gas flow passage bead part 27 and the protrusion height h1b of each of the through hole bead parts 22a to 22f reach a predetermined finished height.

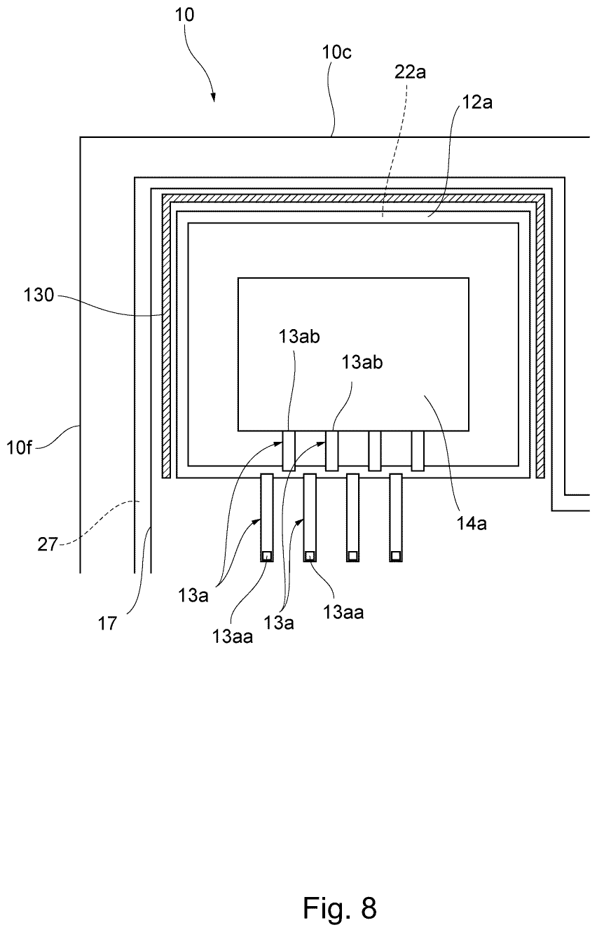

In the pre-pressing step, a known method for suppressing deformation is performed to prevent deformation at portions in the vicinity of the bead parts 12, 17, 22, 27, for example, to prevent deformation at portions of the bottom parts 11, 21. The known method for suppressing deformation is a method for suppressing deformation at portions in the vicinity of the bead parts 12, 17, 22, 27 by disposing a deformation suppressing member 130 along the beads 12, 17, 22, 27 as shown in FIG. 8 in applying a preload. The deformation suppressing member 130 extends for a predetermined length, for example, and has a rectangular shape in cross section orthogonal to the extending direction of the deformation suppressing member 130. The deformation suppressing members 130 are placed on the bottom part 11 of the first separator 10 and the bottom part 21 of the second separator 20. The thickness of the deformation suppressing member 130 used for the first separator 10 is set to a value equal or substantially equal to the distance of the finished height of the bead parts 12, 17 in the joining direction from the front surface 10a of the bottom part 11. In the same manner, the thickness of the deformation suppressing member 130 used for the second separator 20 is set to a value equal or substantially equal to the distance of the finished height of the bead parts 22, 27 in the joining direction from the front surface 20a of the bottom part 21.

The deformation suppressing member 130 used in the known method for suppressing deformation is placed, for example, between two bead parts disposed adjacent to each other with a narrow space therebetween (hereinafter also referred to as “double bead parts”). This is because a portion of a bottom part in the vicinity of the two bead parts disposed adjacent to each other with a narrow space therebetween is easily deformed due to the application of a preload. The deformation suppressing member 130 may be placed at a different position.

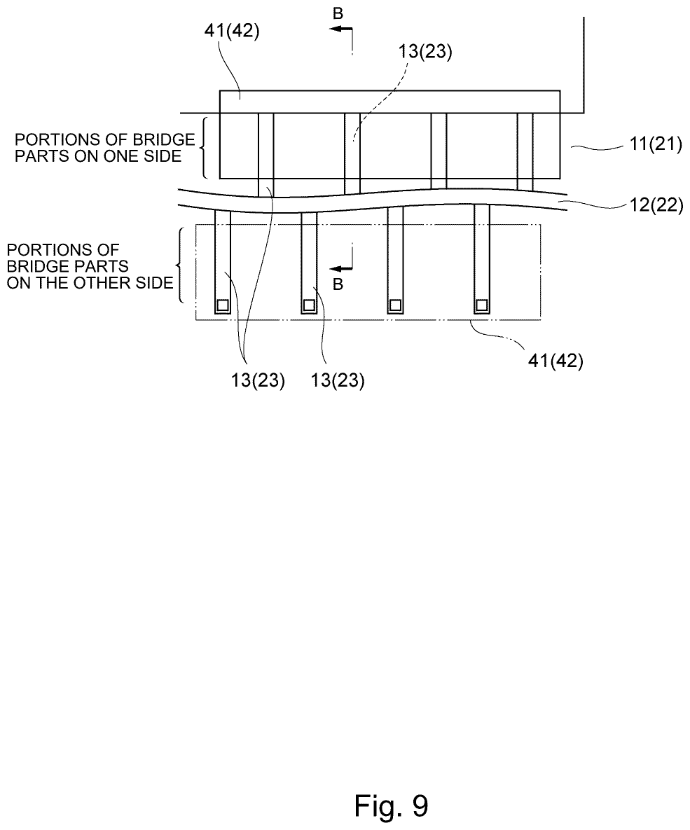

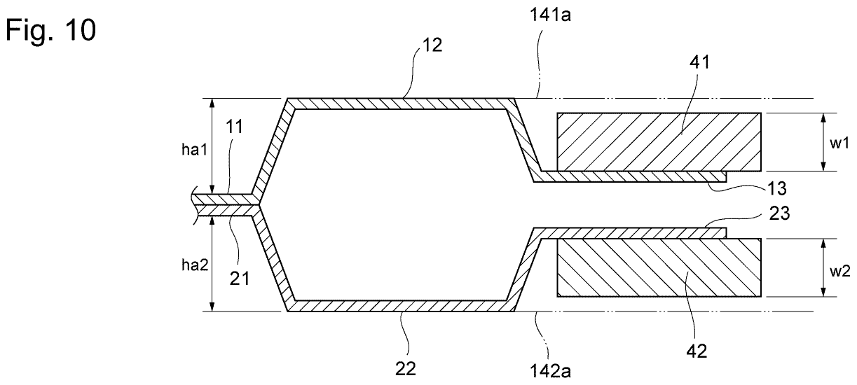

As shown in FIGS. 9 and 10, in the pre-pressing step (step S30), a method for suppressing deformation according to the embodiment of the present disclosure is performed to prevent deformation in a portion of the vicinity of the bead parts 12, 22 to which the plurality of bridge parts 13, 23 are connected. In the method for suppressing deformation according to the embodiment of the present disclosure, in the pre-pressing step, the plurality of bridge parts 13, 23 are sandwiched between a pair of deformation suppressing members 41, 42 to suppress deformation at the plurality of bridge parts 13, 23 and at portions of the bottom parts 11, 21 in the vicinity of the bridge parts 13, 23. FIG. 9 is a diagram of a portion of the fuel battery cell 1 in which the method for suppressing deformation according to the present embodiment is prepared, as viewed from the front surface side, and FIG. 10 is a cross-sectional view showing a cross section taken along line B-B in FIG. 9.

It is difficult to suppress, by the above-described known method for suppressing deformation, the deformation in a portion of the vicinity of the bead parts 12, 22 to which the plurality of bridge parts 13, 23 are connected. To be more specific, portions of the bottom surfaces 11, 21 along the portions of the bead parts 12, 22 to which the plurality of bridge parts 13, 23 are connected, that is, portions of the bottom part 11 between adjacent bridge parts 13 and portions of the bottom part 21 between adjacent bridge parts 23 each have a narrow space and hence, it is difficult or impossible to place the known deformation suppressing members 130. In addition, in a case in which the known deformation suppressing members 130 are placed at the portions of the bottom surfaces 11, 21 along the portions of the bead parts 12, 22 to which the plurality of bridge parts 13, 23 are connected, that is, at all portions of the bottom part 11 between the adjacent bridge parts 13 or at all portions of the bottom part 21 between the adjacent bridge parts 23, a large number of deformation suppressing members 130 are required, so that it is difficult to place the known deformation suppressing members 130.

Even at portions at which it is difficult, by the above-described known method for suppressing deformation, to suppress deformation that occurs in the pre-pressing step, it is possible, by the method for suppressing deformation according to the embodiment of the present disclosure, to suppress deformation that occurs in the preload application step.

As shown in FIGS. 9 and 10, the deformation suppressing members 41, 42 are plate-shaped members and, as shown in FIG. 10, sandwich the plurality of bridge parts 13, 23, which face away from each other, to suppress deformation at the plurality of bridge parts 13, 23 and at portions of the bottom parts 11, 21 in the vicinity of the plurality of bridge parts 13, 23. Examples of a material of the deformation suppressing members 41, 42 include metal, resin, foamed resin, and rubber.

As shown in FIG. 10, thicknesses w1, w2 of the deformation suppressing members 41, 42 in the joining direction are uniform or substantially uniform. As shown in FIG. 9, in the first separator 10, the deformation suppressing member 41 expands along the bottom part 11 in such a way as to cover the entire or substantially the entire plurality of adjacent bridge parts 13 (for example, the plurality of bridge parts 13a) from the front surface side. In the same manner, in the second separator 20, the deformation suppressing member 42 expands along the bottom part 21 in such a way as to cover the entire or substantially the entire plurality of adjacent bridge parts 23 (for example, the plurality of bridge parts 23a) from the front surface side, the plurality of adjacent bridge parts 23 facing away from the plurality of bridge parts 13 covered by the deformation suppressing member 41. As shown in FIG. 9, when viewed from the front surface side, the deformation suppressing member 41 has a shape that conforms to the shape of the portion of the bead parts 12 to which the plurality of adjacent parts 13 are connected, the deformation suppressing member 42 has a shape that conforms to the shape of the portion of the bead parts 22 to which the plurality of adjacent parts 23 are connected, and the deformation suppressing members 41, 42 have, for example, a rectangular shape or a substantially rectangular shape. For example, in the case in which the bead parts 12, 22 extend in a bent state, when viewed from the front surface side, the deformation suppressing member 41 has a shape that is bent along the portion of the bead part 12 to which the plurality of adjacent bridge parts 13 are connected, and the deformation suppressing member 42 has a shape that is bent along the portion of the bead part 22 to which the plurality of adjacent bridge parts 23 are connected. When viewed from the front surface side, the deformation suppressing members 41, 42 have the same shape or substantially the same shape.

As shown in FIG. 9, for example, the deformation suppressing member 41 is placed only on the portions of the bridge parts 13 on one side of the bead part 12, and the deformation suppressing member 42 is placed only on the portions of the bridge parts 23 on one side of the bead part 22. The deformation suppressing member 41 may be placed on only the portions of the bridge parts 13 on the other side of the bead part 12, and the deformation suppressing member 42 may be placed on only the portions of the bridge parts 23 on the other side of the bead part 22. The deformation suppressing members 41 may be placed on the portions of the bridge parts 13 on both one side and the other side of the bead part 12, and the deformation suppressing members 42 may be placed on the portions of the bridge parts 23 on both one side and the other side of the bead part 22.

The thicknesses w1, w2 of the deformation suppressing members 41, 42 are set based on finished protrusion height (finished height) h1a, h2a of the bead parts 12, 22. As described above, the finished heights h1a, h2a of the bead parts 12, 22 are the protrusion heights h1a, h2a of the bead parts 12, 22 that are plastically deformed after a preload is applied (see FIG. 4). For example, the thicknesses w1, w2 of the deformation suppressing members 41, 42 are equal or substantially equal to finished protrusion heights of the bead parts 12, 22 from the bridge parts 12, 22. For example, the thicknesses w1, w2 of the deformation suppressing members 41, 42 are smaller than the finished protrusion heights of the bead parts 12, 22 from the bridge parts 12, 22. For example, in the case in which the deformation suppressing members 41, 42 are made of a soft material, such as foamed resin, the thicknesses w1, w2 of the deformation suppressing members 41, 42 may be larger than the finished protrusion heights of the bead parts 12, 22 from the bridge parts 12, 22.

In the method for suppressing deformation according to the embodiment of the present disclosure, the deformation suppressing member 41 is placed on the plurality of bridge parts 13 and, in the same manner, the deformation suppressing member 42 is placed on the plurality of bridge parts 23. In this case, the deformation suppressing member 41 may be fixed to the plurality of bridge parts 13 by bonding. In the same manner, the deformation suppressing member 42 may be fixed to the plurality of bridge parts 23 by bonding. The deformation suppressing member 41 may be provided to a die described later, which applies a preload, instead of being placed on the plurality of bridge parts 13. In the same manner, the deformation suppressing member 42 may be provided to a die described later, which applies a preload, instead of being placed on the plurality of bridge parts 23. In this case, the deformation suppressing members 41, 42 may be fixed to the dies, or may be integrally formed with the dies.

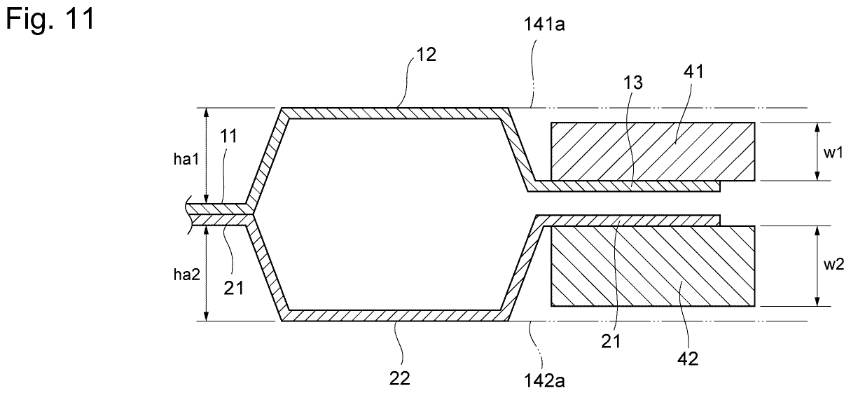

Even for the case in which, as shown in FIG. 11, in the first separator 10 and the second separator 20 joined together, the plurality of bridge parts 23 are not formed in such a way as to face the plurality of bridge parts 13, it is possible to use the above-described method for suppressing deformation according to the embodiment of the present disclosure. In this case, the deformation suppressing member 42 is placed on the bottom part 21 of the second separator 20 at a portion that faces the plurality of bridge parts 13. In addition, the thickness w2 of the deformation suppressing member 42 is equal or substantially equal to, for example, the finished protrusion height of the bead part 22 from the bottom part 21. The thickness w2 of the deformation suppressing member 42 may be smaller than the finished protrusion height of the bead part 22 from the bottom part 21, or may be larger than the finished protrusion height of the bead part 22 from the bottom part 21. The same applies for the case in which, in the first separator 10 and the second separator 20 joined together, the plurality of bridge parts 13 are not formed in such a way as to face the plurality of bridge parts 23.

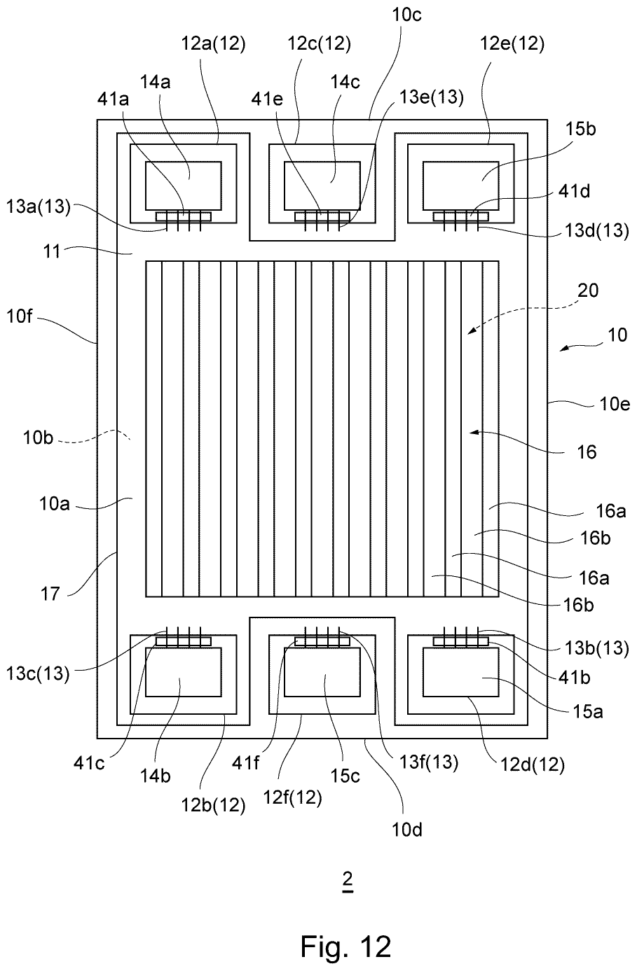

In the pre-pressing step, the first separator 10 and the second separator 20 that are joined together and on which the deformation suppressing member 130 and the deformation suppressing members 41, 42 are placed as described above are disposed between a pressing plate 141a of an upper die 141 and a pressing plate 142a of a lower die 142 as shown in FIG. 12. Next, the first separator 10 and the second separator 20 joined together are pressed in the joining direction by the pressing plate 141a of the upper die 141 and the pressing plate 142a of the lower die 142 to apply a preload to the bead parts 12 and the bead parts 22, and to apply the preload to the bead part 17 and the bead part 27. The pre-pressing is performed on the bead parts 12, 17 of the first separator 10 and the bead parts 22, 27 of the second separator 20 in this manner. The pre-pressing is performed by applying a load of a magnitude that causes the plurality of bead parts 12, 17 and the plurality of bead parts 22, 27 to be plastically deformed, thus allowing the protrusion heights h1a, h1b of the plurality of bead parts 12, 17 to become a uniform or substantially uniform finished height in the first separator 10, and thus allowing the protrusion heights h2a, h2b of the plurality of bead parts 22, 27 to become a uniform or substantially uniform finished height in the second separator 20.

In the above-described pre-pressing step, the conventional method for suppressing deformation is performed by the deformation suppressing member 130 and, in addition, the method for suppressing deformation according to the present embodiment is performed by the deformation suppressing members 41, 42. Therefore, it is possible to suppress deformation at the portions in the vicinity of the two bead parts 12, 22 disposed adjacent to each other with a narrow space therebetween and, in addition, it is also possible to suppress deformation in a portion of the vicinity of the bead parts 12, 22 to which the plurality of bridge parts 13, 23 are connected. Consequently, it is possible to suppress variation in the protrusion heights h1a, h1b, h2a, h2b of the bead parts 12, 17, 22, 27 of the fuel cell separator 1. Therefore, in the fuel battery cell 101 of the fuel cell 100, it is possible to suppress variation in surface pressure that occurs on the bead parts 12, 17, 22, 27 of the fuel cell separator 1 and hence, it is possible to enhance sealing performance of the bead parts 12, 17, 22, 27 of the fuel cell separator 1.

After the above-described pre-pressing step is performed, the fuel cell separator 1 is completed, and the method for manufacturing a fuel cell separator according to the present embodiment is ended.

As described above, the method for manufacturing a fuel cell separator according to the embodiment of the present disclosure can suppress a situation in which the fuel cell separator 1 is deformed due to pre-pressing performed on the bead parts 12, 17, 22, 27.

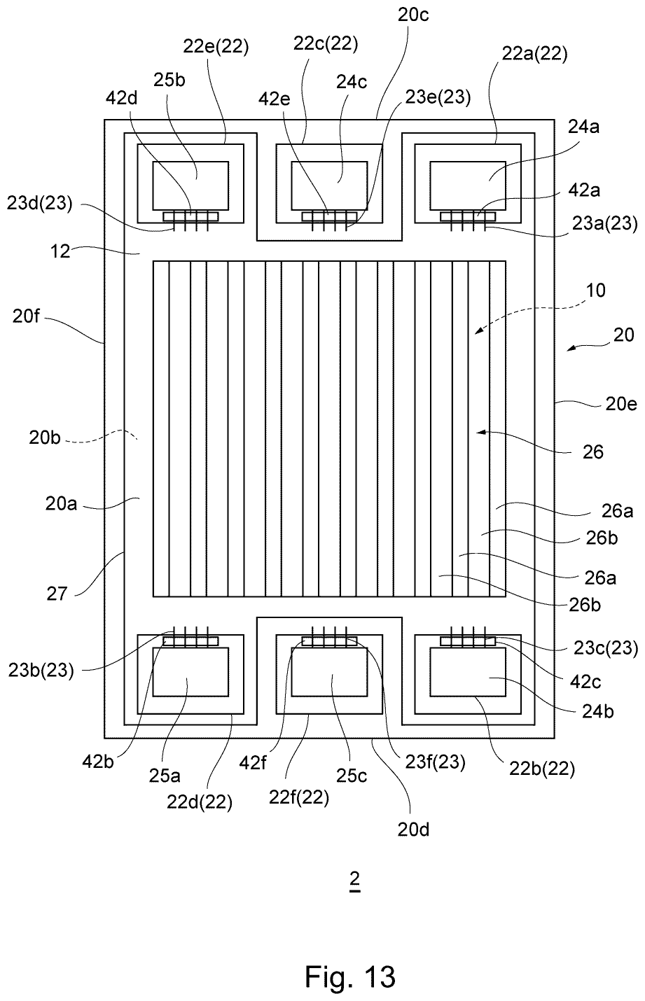

FIGS. 12 and 13 are diagrams schematically showing a fuel cell separator 2 according to another embodiment of the present disclosure. The fuel cell separator 2 differs from the above-described fuel cell separator 1 in that the fuel cell separator 2 includes the above-described deformation suppressing members 41, 42. Hereinafter, components of the fuel cell separator 2 that have the same or identical functions as the components of the above-described fuel cell separator 1 are given the same reference symbols and the description of such components will be omitted, and a description will be made for different configurations.

In the fuel cell separator 2, one or a plurality of deformation suppressing members 41 are attached in such a way as to cover a portion or all of a plurality of adjacent bridge parts 13 of a first separator 10, and one or a plurality of deformation suppressing members 42 are attached in such a way as to cover a portion or all of a plurality of adjacent bridge parts 23 of a second separator 20. To be more specific, as shown in FIG. 12, for example, in the first separator 10, a deformation suppressing member 41a as the deformation suppressing member 41 is attached to a plurality of bridge parts 13a, a deformation suppressing member 41b as the deformation suppressing member 41 is attached to a plurality of bridge parts 13b, a deformation suppressing member 41c as the deformation suppressing member 41 is attached to a plurality of bridge parts 13c, a deformation suppressing member 41d as the deformation suppressing member 41 is attached to a plurality of bridge parts 13d, a deformation suppressing member 41e as the deformation suppressing member 41 is attached to a plurality of bridge parts 13e, and a deformation suppressing member 41f as the deformation suppressing member 41 is attached to a plurality of bridge parts 13f. As shown in FIG. 13, in the second separator 20, a deformation suppressing member 42a as the deformation suppressing member 42 is attached to a plurality of bridge parts 23a, a deformation suppressing member 42b as the deformation suppressing member 42 is attached to a plurality of bridge parts 23b, a deformation suppressing member 42c as the deformation suppressing member 42 is attached to a plurality of bridge parts 23c, a deformation suppressing member 42d as the deformation suppressing member 42 is attached to a plurality of bridge parts 23d, a deformation suppressing member 42e as the deformation suppressing member 42 is attached to a plurality of bridge parts 23e, and a deformation suppressing member 42f as the deformation suppressing member 42 is attached to a plurality of bridge parts 23f.

A fuel battery cell 101 may be formed using the fuel cell separator 2 to which the deformation suppressing members 41, 42 are attached. In this case, in a fuel cell 100, deformation of the first separator 10 and the second separator 20 can be suppressed and hence, it is possible to suppress variation in sealing surface pressure on bead parts 12, 17, 22, 27. Consequently, it is possible to enhance sealing performance of the fuel cell separator 2.

Although the present disclosure has been described heretofore through the above-mentioned embodiments, the technical scope of the present disclosure is not limited to the scope described in the above-mentioned embodiments. It is apparent to those skilled in the art that various modifications or improvements can be made to the above-mentioned embodiments. It is apparent from the description of Claims that the mode to which such modifications or improvements are made can also be included in the technical scope of the present disclosure.

The embodiments described heretofore are for facilitating the understanding of the present disclosure, and are not intended to limit the present disclosure. The above-described embodiments do not limit the use of the present disclosure, and the present disclosure may include anything as its use. The respective constituent elements in the above-mentioned embodiments, as well as their arrangement, materials, conditions, shapes, sizes, etc., are not limited to those exemplified, and can be changed when appropriate. For example, the present disclosure includes differences that occur in the implementation, such as manufacturing tolerances. Furthermore, the constituent elements shown in different embodiments can be partially replaced or combined to the extent that there is no technical contradiction. In addition, the respective components may be suitably and selectively combined in such a way as to achieve at least a portion of the above-described problems and advantageous effects.

What is claimed is:

1. A method for manufacturing a fuel cell separator, the method comprising
a step of plastically deforming a bead part of a first separator and a bead part of a second separator by applying a preload to the bead part of the first separator and the bead part of the second separator, the first separator and the second separator being joined such that the bead part of the first separator and the bead part of the second separator face away from each other, the bead part protruding from a bottom part and a plurality of bridge parts protruding from the bottom part being formed on the first separator, the plurality of bridge parts forming flow passages that communicate with the bead part, the bead part protruding from a bottom part and a plurality of bridge parts protruding from the bottom part being formed on the second separator, the plurality of bridge parts forming flow passages that communicate with the bead part, wherein
in a step of applying the preload, a deformation suppressing member is used to suppress deformation at the plurality of bridge parts and at a portion of the bottom part between the plurality of bridge parts.

2. The method for manufacturing a fuel cell separator according to claim 1, wherein
in the step of applying the preload, the plurality of bridge parts facing away from each other are sandwiched by a pair of the deformation suppressing members to suppress deformation at the plurality of bridge parts and at the portion of the bottom part.

3. The method for manufacturing a fuel cell separator according to claim 2, wherein
one of the pair of the deformation suppressing members is a plate-shaped member that is capable of contacting at least a portion of the plurality of bridge parts formed on the first separator, from a side opposite to a side on which the first separator is joined, in such a way as to cover at least the portion of the plurality of bridge parts, and
another of the pair of the deformation suppressing members is a plate-shaped member that is capable of contacting at least a portion of the plurality of bridge parts formed on the second separator, from a side opposite to a side on which the second separator is joined, in such a way as to cover at least the portion of the plurality of bridge parts.

4. The method for manufacturing a fuel cell separator according to claim 2, wherein
a thickness in a joining direction of each of the pair of the deformation suppressing members is set based on a height in the joining direction of the bead part that is plastically deformed.

5. The method for manufacturing a fuel cell separator according to claim 2, wherein
the preload is applied with the deformation suppressing member placed at least on a portion of the plurality of bridge parts.

6. The method for manufacturing a fuel cell separator according to claim 2, wherein
the deformation suppressing member is placed on a pressing plate in such a way as to face at least a portion of the plurality of bridge parts, the pressing plate being configured to apply the preload.

7. The method for manufacturing a fuel cell separator according to claim 5, wherein
the preload is applied with the deformation suppressing member bonded to at least a portion of the plurality of bridge parts.

8. The method for manufacturing a fuel cell separator according to claim 6, wherein
the preload is applied with the deformation suppressing member bonded to the pressing plate.

9. The method for manufacturing a fuel cell separator according to claim 1, wherein
a plurality of the bead parts are formed in a press forming step.

10. The method for manufacturing a fuel cell separator according to claim 1, wherein
at least one different bead part is formed in the press forming step.

11. A fuel cell separator comprising:
a first separator on which a bead part and a plurality of bridge parts are formed;
a second separator on which a bead part and a plurality of bridge parts are formed; and
a pair of deformation suppressing members each of which is a plate-shaped member, wherein
the first separator and the second separator are joined such that the bead part of the first separator and the bead part of the second separator face away from each other,
one of the pair of deformation suppressing members covers at least a portion of the plurality of bridge parts formed on the first separator, and
another of the pair of deformation suppressing members covers at least a portion of the plurality of bridge parts formed on the second separator.

12. The fuel cell separator according to claim 11, wherein
the bead part of the first separator and the bead part of the second separator exhibit no plastic deformation caused by application of a preload, the first separator and the second separator being joined together.

13. The fuel cell separator according to claim 11, wherein
the bead part of the first separator and the bead part of the second separator are plastically deformed due to application of a preload, the first separator and the second separator being joined together.

14. The fuel cell separator according to claim 11, wherein
a thickness of each of the pair of deformation suppressing members is set based on a height in a joining direction of the bead part that is plastically deformed due to application of a preload.

15. The fuel cell separator according to claim 11, wherein
a deformation suppressing member of the pair of deformation suppressing members is bonded to at least a portion of the plurality of bridge parts.

16. The fuel cell separator according to claim 11, wherein
the first separator includes a plurality of the bead parts, and
the second separator includes a plurality of the bead parts.

17. The fuel cell separator according to claim 11, wherein
the first separator includes a plurality of different bead parts, and
the second separator includes a plurality of different bead parts.
